(19) United States
(12) Patent Application Publication
(10) Pub. No.: US 2022/0046752 A1
(43) Pub. Date: Feb. 10, 2022

(54) METHOD AND APPARATUS FOR PROVIDING GROUP COMMUNICATION IN WIRELESS COMMUNICATION SYSTEM

(71) Applicant: Samsung Electronics Co., Ltd., Suwon-si, Gyeonggi-do (KR)

(72) Inventors: Jicheol LEE, Suwon-si (KR); Sangjun MOON, Suwon-si (KR); Jungshin PARK, Suwon-si (KR); Youngkyo BAEK, Suwon-si (KR)

(21) Appl. No.: 17/278,780

(22) PCT Filed: Oct. 4, 2019
(86) PCT No.: PCT/KR2019/013025

§ 371 Date: Mar. 23, 2021

(30) Foreign Application Priority Data
Oct. 4, 2018 (KR) 10-2018-0118496

(51) Int. Cl. H04W 76/40; H04W 4/08; H04W 4/50; H04W 80/10

(52) U.S. Cl. CPC H04W 76/40; H04W 80/10; H04W 4/50; H04W 4/08

(57) ABSTRACT

Provided are a method and apparatus for providing group communication in a wireless communication system, and a method of supporting a group communication service by a network exposure function (NEF) in a wireless communication system includes receiving, from an application function (AF), a message requesting configuration of a group including an identifier of the AF and an external group identity (ID) of the group; and transmitting, to a unified data management (UDM), a message requesting configuration of the group, wherein, based on the configuration of the group, at least one of creation of the group, deletion of the group, addition of a member of the group, or deletion of a member of the group may be performed.

### TECHNICAL FIELD

The disclosure relates to a wireless communication system, and more particularly, to an apparatus and method for 5G LAN group communication in a wireless communication system.

### BACKGROUND ART

To meet the ever-increasing demand with respect to wireless data traffic since the commercialization of the 4th generation (4G) communication system, there have been efforts to develop an advanced 5th generation (5G) or pre-5G communication system. For this reason, the 5G or pre-5G communication system is also called a beyond 4th-generation (4G) network communication system or post long term evolution (LTE) system.

Implementation of the 5G communication system using ultra-high frequency (millimeter wave (mmWave)) bands, e.g., 60 giga hertz (GHz) bands, is being considered to attain higher data transfer rates. To reduce propagation loss of radio waves and increase a transmission range of radio waves in the ultra-high frequency bands, beamforming, massive multiple-input multiple-output (MIMO), full dimensional MIMO (FD-MIMO), array antenna, analog beamforming, and large-scale antenna techniques are under discussion.

To improve system networks, technologies for advanced small cells, cloud radio access networks (RANs), ultra-dense networks, device to device (D2D) communication, wireless backhaul, moving networks, cooperative communication, coordinated multi-points (CoMP), reception-end interference cancellation and the like are also being developed in the 5G communication system.

In addition, in the 5G system, an advanced coding modulation (ACM) method, e.g., hybrid FSK and QAM modulation (FQAM), sliding window superposition coding (SWSC), and advanced access technology, e.g., filter bank multi carrier (FBMC), non-orthogonal multiple access (NOMA), and sparse code multiple access (SCMA) are being developed.

Furthermore, a method of providing 5G local area network (LAN) group communication for providing a virtual local network in a smart factory, enterprise, or home is under development.

### DESCRIPTION OF EMBODIMENTS

### Technical Problem

Various embodiments of the disclosure provide a method and apparatus for providing group communication in a local network in a wireless communication system.

The disclosure provides a network structure and a user plane structure for 5G local area network (LAN) group communication services, and provides a method and apparatus for managing a 5G LAN group and group members, a provisioning method for group communication, and a method of activating a group communication session for group communication in various embodiments.

### Solution to Problem

The disclosure relates to a method and apparatus for providing group communication in a wireless communication system, and according to an embodiment, a method of supporting a group communication service by a network exposure function (NEF) in a wireless communication system includes receiving, from an application function (AF), a message requesting configuration of a group including an identifier of the AF and an external group identity (ID) of the group; and transmitting, to a unified data management (UDM), a message requesting configuration of the group, wherein, based on the configuration of the group, at least one of creation or deletion of the group, or addition or deletion of a member of the group may be performed.

### Advantageous Effects of Disclosure

According to various embodiments of the disclosure, an apparatus and method may enable an admin user of a 5G local area network (LAN) group to administrate a 5G LAN group communication group, make provision for creation of a 5G LAN group, and dynamically activate a 5G LAN group communication session.

The effects according to the disclosure are not limited thereto, and throughout the specification it will be clearly appreciated by those of ordinary skill in the art that there may be other effects unmentioned.

### BRIEF DESCRIPTION OF THE DRAWINGS

FIG. 1 illustrates a network structure and interfaces in a wireless communication system, according to some embodiments of the disclosure.

FIG. 2 illustrates a user plane structure for a 5G local area network (LAN) group communication service, according to some embodiments of the disclosure.

FIG. 3 is a diagram illustrating a group creation or deletion procedure by an admin subscriber, according to some embodiments of the disclosure.

FIG. 4 is a diagram illustrating a procedure of adding or deleting a member of a group by an admin subscriber, according to some embodiments of the disclosure.

FIG. 5 illustrates a structure of domains for managing members of a group communication service, groups, and group members, according to some embodiments of the disclosure.

FIG. 6 is a diagram illustrating a provisioning procedure for a group communication session, according to some embodiments of the disclosure.

FIG. 7 is a diagram illustrating a method of activating a group communication session by using a user equipment (UE) policy delivery and protocol data unit (PDU) session creation procedure, according to some embodiments of the disclosure.

FIG. 8 is a diagram illustrating a method of activating a group communication session by using a PDU session update procedure, according to some embodiments of the disclosure.

FIG. 9 is a diagram illustrating a method of joining a group communication session by a UE using a PDU session creation procedure, according to some embodiments of the disclosure.

FIG. 10 is a flowchart of a method of supporting a group communication service by a network exposure function (NEF), according to some embodiments of the disclosure.

FIG. 11 is a flowchart of a method of supporting a group communication service by an application function (AF), according to some embodiments of the disclosure.

FIG. 12 is a block diagram illustrating a structure of a network function (NF), according to some embodiments of the disclosure.

FIG. 13 is a block diagram illustrating a structure of a UE, according to some embodiments of the disclosure.

### MODE OF DISCLOSURE

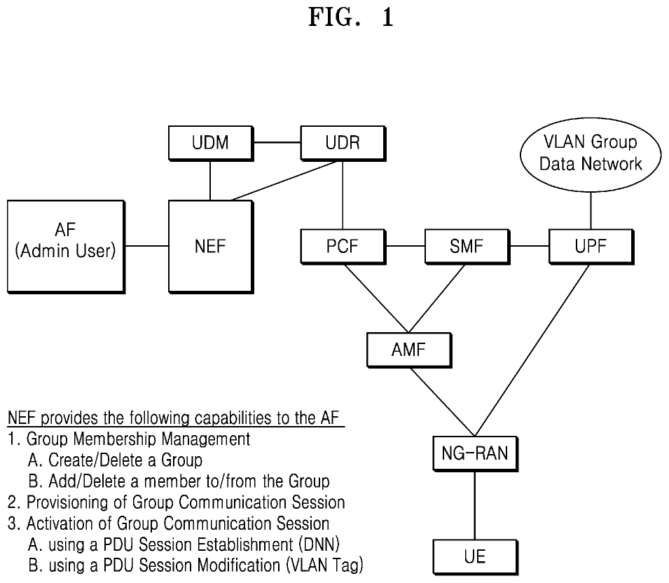

In the disclosure, functions required for 5G local area network (LAN) group communication in a network structure as shown in FIG. 1 will be described. FIG. 1 illustrates a network structure and interfaces in a wireless communication system, according to some embodiments of the disclosure.

A 5G LAN group communication session may be defined by a tuple of single network slice selection assistance information (S-NSSAI) and a data network name (DNN). In a case of supporting a virtual LAN (VLAN) tagging for a 5G LAN group, a 5G LAN group communication session may be defined by S-NSSAI, a DNN, and a VLAN tag. The 5G LAN group communication service may be limited by restricting creation of a packet data unit (PDU) session by using particular S-NSSAI and DNN. Furthermore, restriction on a service available area for the 5G LAN group communication service may be made by using a local area data network (LADN) DNN and establishing an LADN service area (i.e., a list of tracking areas (TAs)) to prevent use of the group communication service in other areas than the established area.

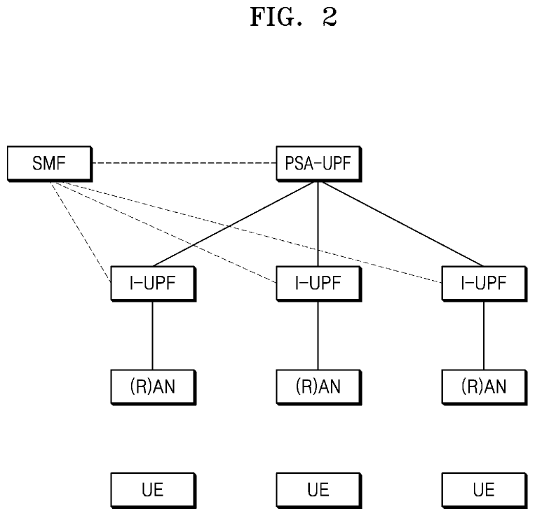

The disclosure proposes a user plane structure as shown in FIG. 2 for 5G LAN group communication. FIG. 2 illustrates a user plane structure for 5G LAN group communication, according to some embodiments of the disclosure.

A session management function (SMF) is responsible for transmission of user data traffic for a group communication session. A packet session anchor user plane function (PSA-UPF) provides group data traffic transmission, multicast, broadcast, and proxy address resolution protocol (proxy ARP) functions for a group communication session. The proxy ARP function is a technology for enabling a device connected to an Ethernet network to respond to an ARP request for an IP address that is not present in the network. A device for performing the proxy ARP knows a destination of the corresponding traffic, so it responds with its own media access control (MAC) address for an original destination MAC address, to be able to receive an IP packet for the original destination and forward it to the original destination address.

An intermediate UPF (I-UPF) is responsible for delivering a user data packet (packet data unit (PDU)) in a group communication session. The PSA-UPF is responsible for policy enforcement of a group policy for a group communication session. The group policy for a group communication session may include information such as a group quota and a group aggregated maximum bit rate (AMBR) of the group communication session. The group quota of the group communication session may include information about an available amount allocated for the group communication session. The group quota of the group communication session may include information as in the following:
the number of bytes of uplink and downlink packet data transmitted and received through a user plane
a user belonging to a group which may be represented by a sum of the numbers of uplink/downlink packet data transmitted and received.
the number of uplink/downlink packet data that passes a PSA-UPF designated for the group communication service
the number of bytes of uplink and downlink packet data transmitted and received through a control plane
temporal information that may use the group communication session. For example, it may correspond to the following information:
total available time from the present time (e.g., 20 minutes, 1 hour, 10 seconds, etc.)
an absolute time based period available for packet transmission and reception including time zone information (e.g., from Sep. 20, 2018 09:00:00 KST to Oct. 30, 2018 12:00:00 KST)
the number of times of intermittent packet transmission or reception (e.g., five times)

Group aggregated maximum bit rate (AMBR) information is about a maximum rate available for transmission when members involved in the group communication using the group communication session transmit or receive the group session at the same time. In a case of using a group communication session, when a UE involved in the group communication session as in FIG. 2 requests creation of a group communication session (i.e., requests joining in a group communication session), the SMF selects an assigned PSA-UPF. When the group communication session requested by the UE already exists, it is allocated to a PSA-UPF for the existing group communication session. When the PSA-UPF is not connected to base station (BS) or a (radio) access network ((R)AN) connected to the UE that requests creation of the current group communication session, the SMF needs to select an I-UPF that may be connected by the BS connected to the UE. Furthermore, the SMF connects a path between the selected I-UPF and the PSA-UPF. In a case that the group communication session is created in the user plane structure and the group AMBR information is configured for the created group communication session, the PSA-UPF controls a transmission rate not to exceed the AMBR allocated for the group communication session.

Furthermore, the SMF manages a maximum number of created PDU sessions and a maximum number of activated PDU sessions.

In various embodiments of the disclosure, included is a method of managing a group and members of the group with operations of creating/deleting a group and adding or deleting a member belonging to the group in the wireless communication system. In some embodiments, in a network exposure function (NEF) node, an operator may accept a request of an admin subscriber, and manage a group by changing a group data record and a user data record in a user data repository (UDR) to create or delete a group and add or delete a group member.

In various embodiments of the disclosure, a provisioning procedure for a group communication session in a wireless communication system includes a method of performing procedures of instantiation of an NF, updating of configuration information of the existing NF, and updating of policy information, in response to the operator's approval of the request of the admin subscriber of the group communication. In some embodiments, in the NEF node, the operator may accept the provisioning request for a 5G LAN service from the admin subscriber, and make provision for a group communication session including procedures of allocation and arrangement of a dedicated NF for the 5G LAN service, modification to configuration information of the existing NF, and modification to the user policy.

In various embodiments of the disclosure, the procedure of activating a group communication session in a wireless communication system includes a method of performing a mandatory session creation or modification procedure in response to the operator's approval of the admin subscriber's activation request for the group communication session. The mandatory session creation or modification includes a method with a PDU session creation procedure or a PDU session modification procedure based on a network triggering method at an instant PDU session creation indication or application triggering request included in a UE policy. In some embodiments, in the NEF node, the operator may accept the request of the admin subscriber to activate the 5G LAN group communication service, and perform the requested activation of the group communication service.

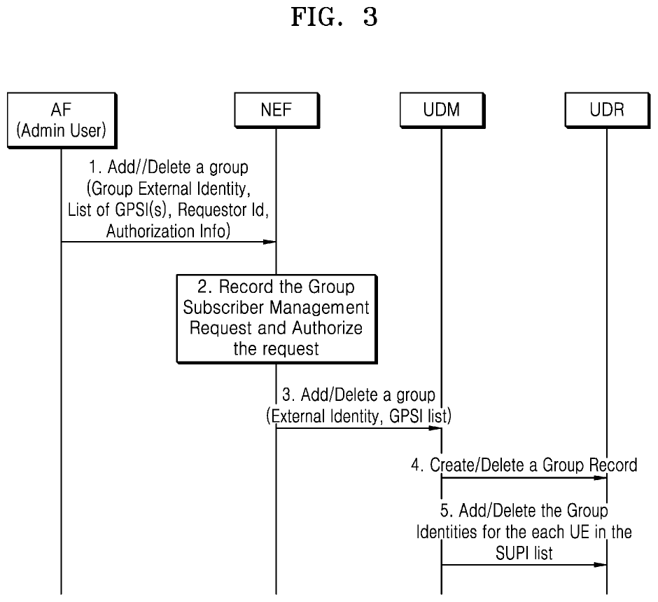

A first embodiment of the disclosure is an embodiment regarding a procedure of managing group members, which may be performed as in a procedure of FIG. 3. The first embodiment of the disclosure is not, however, limited to the procedure of FIG. 3, but may include a procedure other than the procedure of FIG. 3.

FIG. 3 is a diagram illustrating a group creation or deletion procedure by an admin subscriber, according to some embodiments. Referring to FIG. 3, the procedure of the first embodiment of the disclosure will now be described.

Step 1. An AF (i.e., an admin subscriber) requests an NEF to add (or delete) a group. Such a request may include an external group identifier, a generic public subscription identifier (GPSI) list, a requester ID, and authorization information. The requester ID refers to a user authorized by the NEF for group administration. The requester ID may correspond to a user belonging to an admin group. The authorization information is information about authorization given to the authorized user, and the NEF may authorize the user, who requested, through a process of checking whether the requester ID and the authorization information are for the authorized user.

Step 2. The NEF may store the request, and the operator may accept (or approve) the request.

Step 3. When the operator accepts (or approve) the request, the NEF may use a service operation of a unified data management (UDM) to request the UDM to create (or delete) a group with a list of UEs.

Step 4. The UDM may use a service operation of a unified data repository (UDR) to create or delete a group record.

Step 5. For the respective UEs in a group, the UDM may use the service operation of the UDR to create or delete a group identified by an external or internal group identifier.

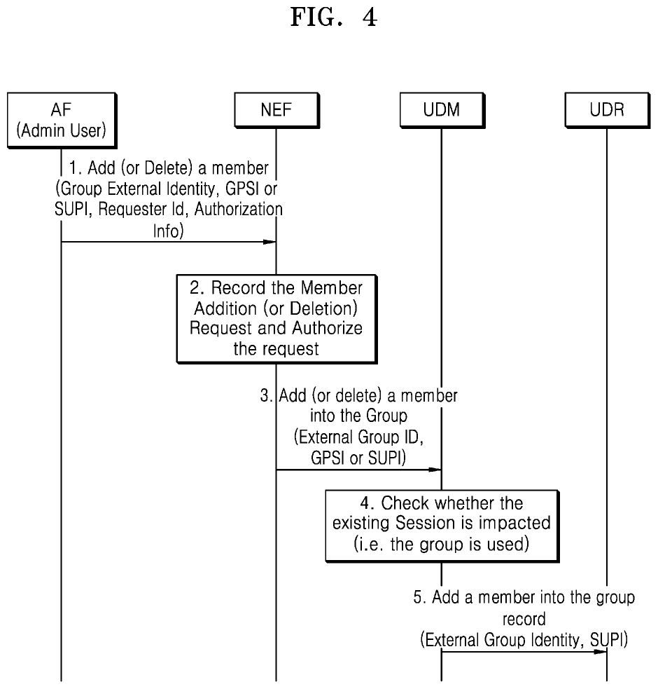

A second embodiment of the disclosure is an embodiment of a procedure of adding or deleting a group member, which may be performed as in a procedure of FIG. 4. The second embodiment of the disclosure is not, however, limited to the procedure of FIG. 4, but may include a procedure other than the procedure of FIG. 4.

FIG. 4 is a diagram illustrating a procedure of adding or deleting a member of a group by an admin subscriber, according to some embodiments. Referring to FIG. 4, the procedure of the second embodiment of the disclosure will now be described.

Step 1. An AF (i.e., an admin subscriber) may request an NEF to add or delete a member to or from a group. Such a request may include an external group identifier, a member (UE) identifier (e.g., GPSI or SUPI), a requester ID, and authorization information.

Step 2. The NEF may store the request of the AF, and the operator may accept (or approve) the request.

Step 3. When the operator accept (or approve) the request, the NEF may use a service operation of the UDM to request the UDM to add or delete a member to or from the group.

Step 4. The UDM may use a service operation of UDR to add or delete a member identified by a GPSI or a subscription permanent identifier (SUPI) to or from the group.

Step 5. For each user (or member), the UDM may use the service operation of UDR to add or delete a group identified by an internal group identifier or an external group identifier to or from a group record.

A third embodiment of the disclosure is some embodiments regarding a configuration of group management data.

In the embodiment, for subscriber group management, group subscription information as represented in Table 1 may be used. The group subscription information is not, however, limited to the following Table 1, but may also include information other than the information represented in the Table 1.

TABLE 1

| Subscription | | |
|---|---|---|
| information | | |
| Type | Field | Description |
| Subscription | External | External group identifier of a group to which |
| to group | group | the subscriber belongs |
| | identifier | |
| Information | Internal | internal group identifier of a group to which |
| | group | the subscriber belongs |
| | identifier | |
| | SUPI list | A list of identifiers (SUPIs) of subscribers |
| | | belonging to the group |
| | Group | An indicator indicating a type of a group |
| | type | For example, the group type may include a |
| | | 5G LAN user group or a 5G LAN admin |
| | | group. |
| | Domain | An identifier to identify a group domain |
| | identifier | (i.e., a logical group management area). |
| | | Members of an admin group may manage a |
| | | user group in the group domain and members |
| | | of the user group. |

An admin user may belong to a 5G LAN admin group, and may be able to add or delete a 5G LAN user group and a group member of the 5G LAN user group. A user (UE) may belong to a limited number of groups, and group subscription data stored in the UDR may indicate association between a subscriber and a group. The internal group identifier may refer to a group.

Group management may be defined by operations to add/delete or modify data in the UDR repository. For example, creating a new group with a list of group members may be implemented as creating a record in a repository for storing data having the form as represented in the Table 1. Furthermore, adding or deleting a member to or from a group may be defined as adding or deleting an SUPI to or from the group subscription information.

Along with this, a group domain may be configured. The group domain may be a logical area for group management of a 5G LAN group communication service, and a member of an admin group in the logical area (i.e., an admin subscriber) may administrate the user group and members of the user group. The group domain may be used to identify a customer who uses the 5G LAN service.

The domain subscription information may include a domain identifier, an admin group identifier, and one or more user group identifiers. The user group identifier may be used to identify a group as defined in the Table 1. The domain subscription information may be defined as in Table 2. The domain subscription information is not, however, limited to the following Table 2, but may also include information other than the information represented in the Table 2.

TABLE 2

| Subscription | | |
|---|---|---|
| information | | |
| Type | Field | Description |
| Domain | Domain | An identifier for identifying a group domain |
| subscription | identifier | including an admin group and a plurality of |
| information | | user groups |
| | Admin | An identifier of the admin group belonging to |
| | group | the domain. The admin group identifier may be |
| | identifier | an external group identifier or an internal |
| | | group identifier. A member belonging to the |
| | | admin group may create or delete a user group |
| | | belonging to the domain or add or delete a |
| | | member of the admin group or the user group. |
| | List of | A list of user group identifiers belonging to |
| | user group | the domain. The user group identifier may be |
| | identifiers | an external group identifier or an internal |
| | | group identifier. |

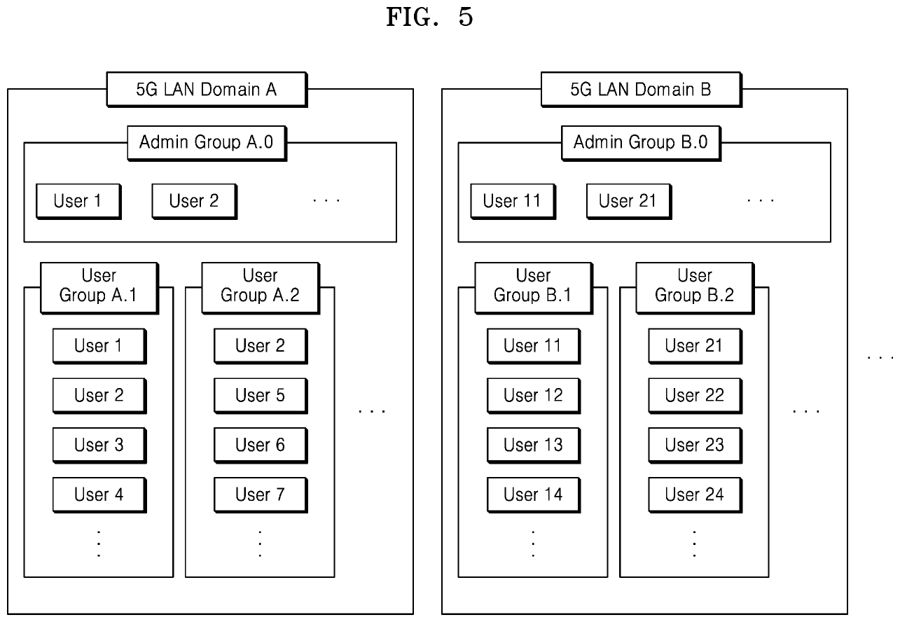

FIG. 5 illustrates a structure of domains for managing members of a group communication service, groups, and group members, according to some embodiments of the disclosure. Referring to FIG. 5, there may be an admin group and a plurality of user groups in 5G LAN domain A. The 5G LAN domain A is an example of a group domain for group management of the aforementioned 5G LAN group communication service. A user belonging to the admin group of the domain A may mange (i.e., add or delete) a user group in the domain A, and may add a member to the admin group or a user group in the domain A or delete a member belonging to the admin group or a user group in the domain A. The user belonging to the admin group may request, activate, or deactivate a provisioning procedure for a group communication session (5G LAN communication session). The member (or user) belonging to the admin group may also belong to a user group. A member (or user) may belong to the admin group, multiple user groups, or both the admin group and multiple user groups. For example, referring to FIG. 5, user 2 is a member of the admin group, user group A1, and user group A2. The admin user belonging to one domain is not allowed to administrate a group belonging to another domain.

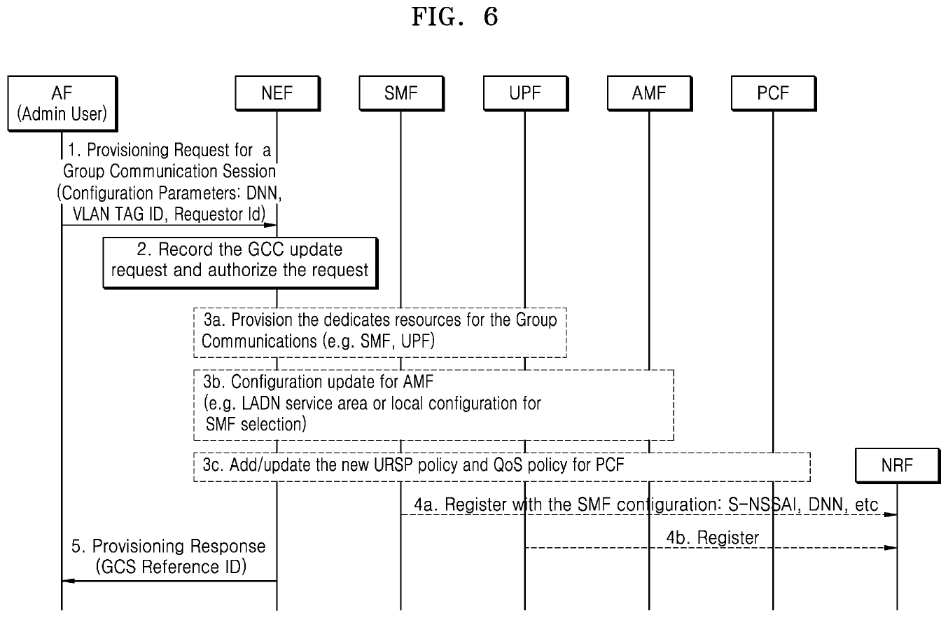

A fourth embodiment of the disclosure is an embodiment regarding a provisioning procedure for a group communication session, which may be performed as in a procedure of FIG. 6. The fourth embodiment of the disclosure is not, however, limited to the procedure of FIG. 6, but may include a procedure other than the procedure of FIG. 6.

FIG. 6 is a diagram illustrating a provisioning procedure for a group communication session, according to some embodiments. Referring to FIG. 6, the procedure of the fourth embodiment of the disclosure will now be described.

Step 1. An AF (i.e., an admin subscriber) may request an NEF to make provision for a group communication session with provisioning parameters. The request message may include a group identifier, a subscription identifier (UE identifier) of the requester, and authorization information.

The provisioning parameters may be used by the NEF or operation support systems (OSSs)/business support systems (BSSs) to prepare a network function for a group communication session. Furthermore, the provisioning parameters may be used by the NEF or the OSS/BSS to add or modify configuration information about the existing NF or add or modify policy information.

In some embodiments, the provisioning parameters may include parameters as in the following. The provisioning parameters are not, however, limited to the following parameters, but may also include other parameters than the following parameters.
group communication identifier tuple: S-NSSAI, DNN, VLAN TAG
PDU session type: IPv4, IPv6, IPv4v6, Ethernet or unstructured data
IP address allocation method: for IPv4, using DHCP or static IP address allocation for the group member (i.e. per UE). For IPv6, using DHCPv6 or stateless address auto-configuration
DN authorization method: no authorization, authorization for each UE, authorization for each group (e.g., using a group code shared in the group)
PDU session capacity: a maximum number of created PDU sessions
LADN indicator: an indicator indicating whether the DNN is a LADN DNN or not
geographical area: an item representing a geographical area
whether the service area is limited: an indicator indicating whether to deactivate or release the PDU session when the SMF detects that the UE is outside the service area
group aggregated maximum bit rate (AMBR): a maximum transmission rate aggregated for group communication
data network access identifier (DNAI): an identifier of a user plane function (UPF) that provides 5G LAN group communication

Step 2. The NEF stores (or records) the provisioning request of the AF, and the operator may approve the request stored by the NEF.

Step 3a. The NEF may request the OSS/BSS to prepare a suitable NF resource (e.g., an NF having the requested provisioning parameters, or a dedicated SMF and/or UPF for group communication session requested for provisioning) based on the provisioning parameters.

Step 3b. The NEF may update (or modify) configuration information for the NF existing. For example, the configuration information for the NF to be updated (or modified) may include LADN DNN or LADN service area information, and the NEF may update configuration information for the AMF existing.

Step 3c. The NEF may add or update (or change) a UE policy and a session manager (SM)/quality of service (QoS) policy.

Step 4. An NF newly created by the provisioning request, i.e., an instantiated NF, may register itself in an NF repository function (NRF) for another NF (e.g., an access and mobility management function (AMF)) to discover and select an SMF based on the registration information (e.g., DNN, S-NSSAI, etc.).

Step 5. After completing provision for NFs and update (modification) of the configuration information and policy data for the NF, the NEF may respond to the AF with a group communication session reference identifier. The group communication session reference identifier is an identifier allocated and managed by the NEF, which may refer to the provisioning parameters received by the NEF from the AF. The NEF may refer to identification information (e.g., including a DNN, an S-NSSAI and a VLAN TAG) for the group communication session created through the provisioning procedure by an operation support system (OSS) and a business support system (BSS) in the operator.

In the step 5, the NEF may successfully perform the provisioning procedure for the group communication session, and when identification information for the group communication session is created, transmit the identification information for the group communication session (i.e., DNN S-NNAI tuple, DNN, S-NSSAI, VLAN TAG, etc.) in a response message.

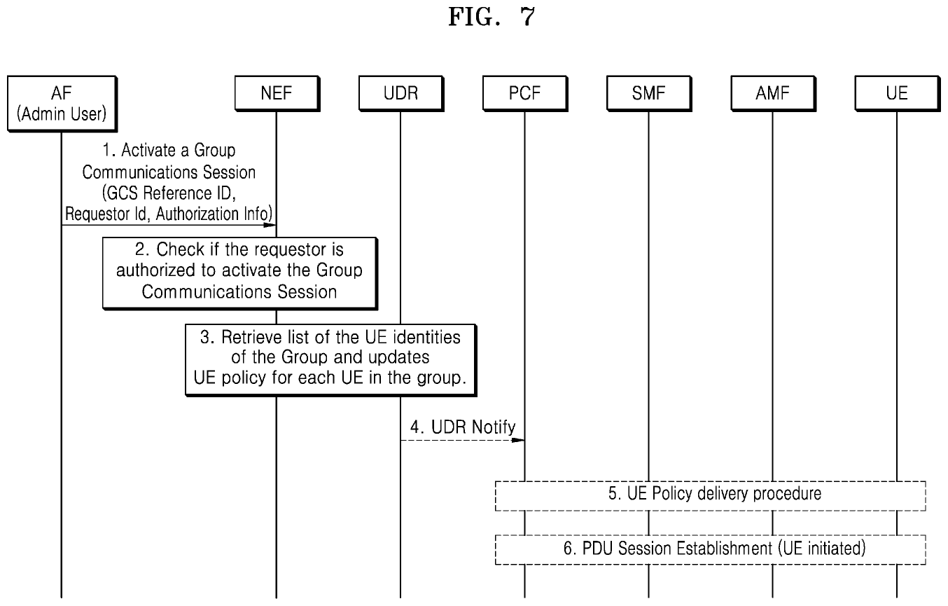

A fifth embodiment of the disclosure is an embodiment regarding an activation procedure of a group communication session, which may be performed as in a procedure of FIG. 7. The fifth embodiment of the disclosure is not, however, limited to the procedure of FIG. 7, but may include a procedure other than the procedure of FIG. 7.

FIG. 7 is a diagram illustrating a method of activating a communication session by using a UE policy delivery and PDU session creation procedure, according to some embodiments. Referring to FIG. 7, the procedure of the fifth embodiment of the disclosure will now be described.

Step 1. An AF (i.e., an admin user) may request an NEF to activate a group communication session. The request message may include a group identifier, a group communication session reference ID, a subscription identifier (UE identifier) of the requester, and authorization information.

Step 2. The NEF may check whether the requester is authorized to activate a group communication session.

Step 3. The NEF may receive a list of subscription identifiers (or UE identifiers), and update (or change) a UE policy about members (i.e., UEs) belonging to a group.

Step 4. A UDR notifies a policy control function (PCF) of information indicating that the policy data (e.g., the UE policy about members of the group) is updated (or changed). In this case, it may be assumed that the PCF has already been subscribed to information notification about a change in policy data of the UDR.

Step 5. The PCF may start a UE policy delivery procedure. In order for the UE to be able to instantaneously create a PDU session corresponding to the group communication session after receiving the UE policy, a UE route selection policy (URSP) may include an indicator indicating instantaneous creation of a PDU session.

Step 6. The UE receives the UE policy, and when the received UE policy includes the indicator indicating instantaneous creation of a PDU session, performs a PDU session creation process. The UE may use configuration parameters encoded with route selection components received from the URSP while performing the PDU session creation procedure.

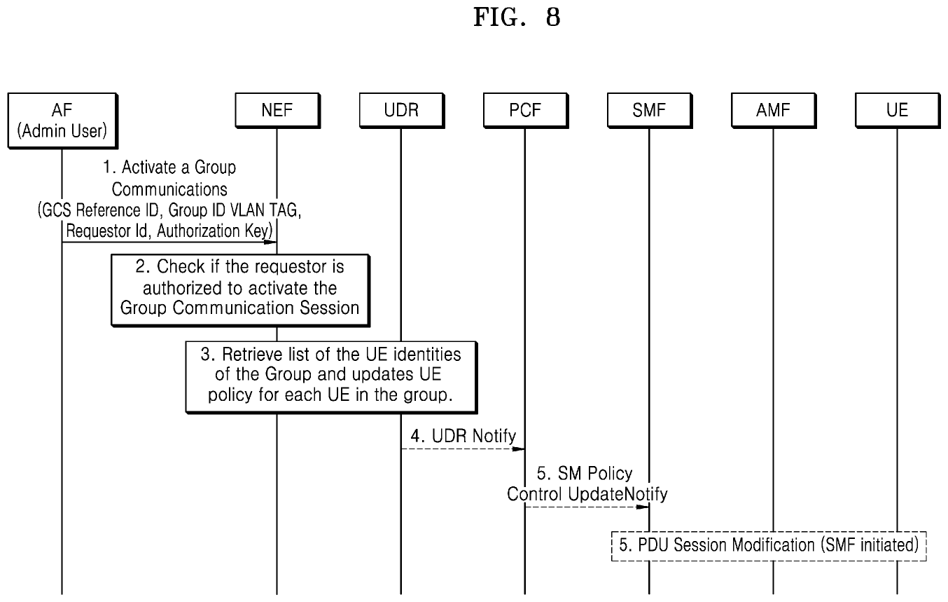

A sixth embodiment of the disclosure is an embodiment regarding an activation procedure of a group communication session. The sixth embodiment of the disclosure may be performed as in a procedure of FIG. 8. The sixth embodiment of the disclosure is not, however, limited to the procedure of FIG. 8, but may include a procedure other than the procedure of FIG. 8.

FIG. 8 is a diagram illustrating a method of activating a group communication session by using a PDU session update procedure, according to some embodiments. Referring to FIG. 8, the procedure of the sixth embodiment of the disclosure will now be described.

Step 1. An AF (i.e., an admin subscriber) may request an NEF to activate a group communication session. The request message may include a group identifier, a group communication session reference ID, a subscription identifier (UE identifier) of the requester, and authorization information.

Step 2. The NEF may check whether the requester is authorized to activate a group communication session.

Step 3. The NEF may receive a list of subscription identifiers (or UE identifiers), and update (or change) a UE policy about members (i.e., UEs) belonging to a group.

Step 4. A UDR may notify a PCF of information indicating that policy data (e.g., the UE policy about members of a group) is updated (or changed). In this case, it may be assumed that the PCF has already been subscribed to information notification about a change in policy data of the UDR.

Step 5. The PCF may perform an SM policy control update notification process, to update (or change) policy information for a PDU session that has been created. For example, the PCF may perform the SM policy control notification process to perform a PDU session modification process in which to add a VLAN TAG available to the UE for the PDU session that has been created between the UE and the SMF to the VLAN TAG list allowed for the UE.

Step 6. The SMF may perform the PDU session modification process to deliver the VLAN TAG to the UE. Upon receiving the VLAN TAG, the UE adds the received VLAN TAG to a VLAN TAG list allowed to be used by an application program of the UE.

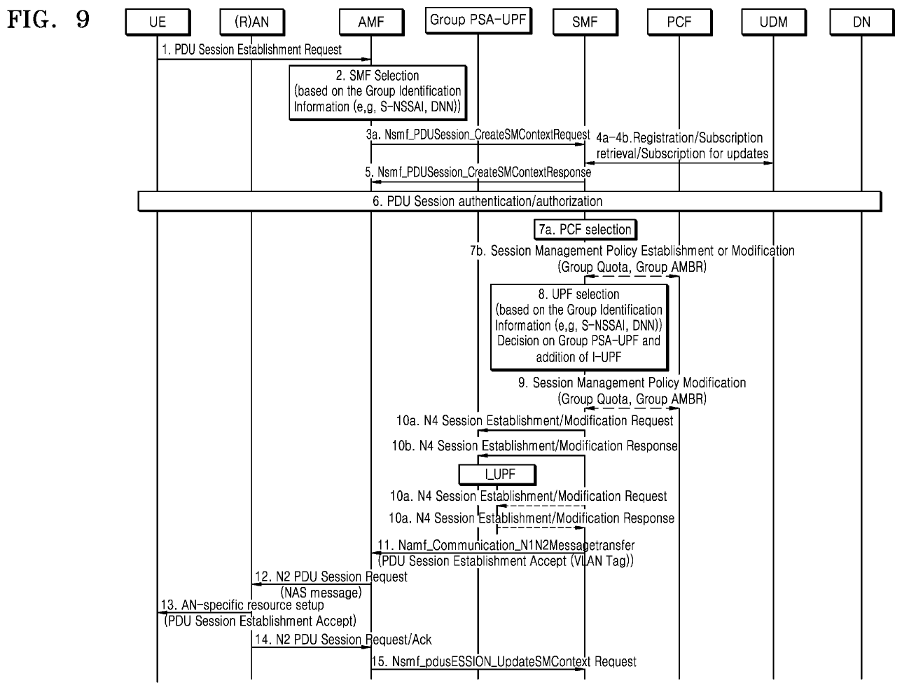

A seventh embodiment of the disclosure is an embodiment regarding a method of joining a group communication session. The seventh embodiment of the disclosure may be performed as in a procedure of FIG. 9. The seventh embodiment of the disclosure is not, however, limited to the procedure of FIG. 9, but may include a procedure other than the procedure of FIG. 9.

FIG. 9 is a diagram illustrating a method of joining a group communication session by using a PDU session creation procedure of a UE, according to some embodiments. Referring to FIG. 9, the procedure of the seventh embodiment of the disclosure will now be described.

In some embodiments, a UE (a group user) subscribed to group communication may join a group communication session through a PDU session creation procedure.

Step 1. The UE may deliver a PDU session creating message including group communication identification information of a group communication session to an AMF, to join the group communication session. The group communication identification information may include an S-NSSAI and a DNN.

Step 2. The AMF may use the identification information of the group communication session to select an SMF.

Step 7. The SMF may deliver the identification information of the group communication session to a PCF, and the PCF may deliver policy information for the group communication session to the SMF. The policy information for the group communication session may include a group quota and a group AMBR.

Step 10a/b. The SMF may select a group PSA-UPF, and deliver the group AMBR and group quota information to the group PSA-UPF.

Step 10c/d. The SMF may determine whether to create an I-UPF, and add the I-UPF when required. For example, the SMF may add the I-UPF to connect between an (R)AN and the group PSA-UPF, when the (R)AN is not able to connect the group PSA-UPF directly to an N3 tunnel based on a topology.

Step 11. The SMF may deliver a VLAN-TAG to the UE.

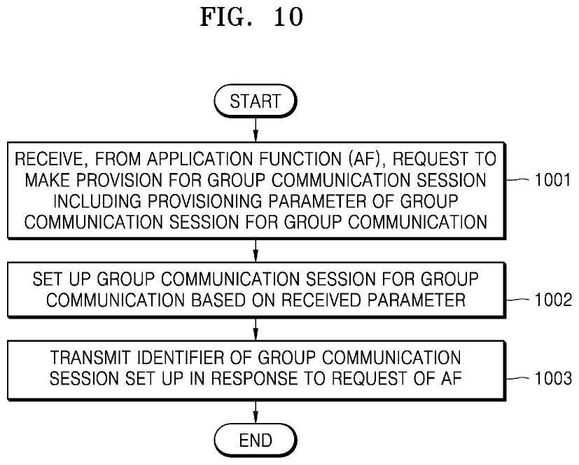

FIG. 10 is a flowchart of a method of supporting a group communication service by an NEF, according to some embodiments of the disclosure.

In operation 1001, the NEF may receive, from an application function (AF), a request to make provision for a group communication session for group communication, the request including provisioning parameters for the group communication session. In this case, the provision for the group communication session may be configuring the group communication session for group communication.

In some embodiments, the AF may correspond to an admin user (or a UE) able to administrate a group for group communication.

In some embodiments, the provisioning parameters for the group communication session may include a group communication identifier tuple, a PDU session type, an IP address allocation method, a DN authorization method, a PDU session capacity, an LADN indicator, a geographical area, whether a service area is limited, a group AMBR, a data network access identifier, etc.

In operation 1002, the NEF may set up a group communication session for group communication based on the parameters received from the AF.

In some embodiments, the NEF may configure NFs for group communication based on the provisioning parameters for the group communication session, and set up the group communication session for group communication by changing policies related to the group communication based on the provisioning parameters for the group communication session.

In some embodiments, the NEF may create dedicated SMF and UPF for the group communication based on the provisioning parameters for the group communication session, and configure the NFs for the group communication by updating configuration information of an AMF in relation to the group communication.

In some embodiments, the NEF may change the policies related to the group communication by changing a UE policy and session manager (SM)/quality of service (QoS) policies in relation to the group communication based on the provisioning parameters for the group communication session.

In operation 1003, the NEF may transmit, to the AF, an identifier of the established group communication session including information regarding the group communication session in response to the request of the AF.

In some embodiments, the NEF may make provision for the group communication session at the request of the AF, and notify the AF that provision for the group communication session is done by transmitting an identifier of the group communication session.

In some embodiments, the NEF may receive, from the AF that received the identifier of the group communication session, a request to activate the group communication session including the identifier of the group communication session and UE identifiers of members (i.e., UEs) included in the group. Furthermore, the NEF may check whether the AF that requested activation of the group communication session is authorized to activate the group communication session. Moreover, the NEF may update a UE policy about the UEs included in the group involved in the group communication based on the UE identifiers for the UEs and NFs for group communication to activate the group communication session.

In some embodiments, the NEF may update the UE policy about the UEs for the UEs and NFs for group communication to create a PDU session for the group communication.

In some embodiments, the NEF may deliver a PDU session creation message including identification information for the group communication session to the NFs for group communication, so that the NFs for group communication may create a PDU session based on the identification information of the group communication session.

In some embodiments, the NEF may update the UE policy about the UEs for the UEs and NFs for group communication to change the existing PDU session for the group communication.

Furthermore, in some embodiments, the NEF may add or delete a group for the group communication. The NEF may receive, from the AF, a request to add or delete a group including information about the group to be added or deleted, and when the operator accepts the request of the AF, request the UDM to add or delete the group so that a group record corresponding to the group is added or deleted in the UDR based on the information about the group to be added or deleted.

In some embodiments, the group record may include group subscription information of UEs included in the group, and domain subscription information of the group. In this case, the domain may be a kind of logical area for managing a group, and may be referred to as a group domain.

In some embodiments, the group subscription information may include an external group identifier of the group, an internal group identifier of the group, a list of SUPIs of UEs included in the group, a group type of the group, and a domain identifier of the group.

In some embodiments, the domain subscription information may include an identifier of a domain including the group, an identifier of an admin group included in the domain, and an identifier of a group included in the domain.

In some embodiments, the NEF may add or delete a UE (e.g., a member) to or from a group for group communication. The NEF may receive, from the AF, a request to add or delete a UE to or from a group, the request including information about the group and information about the UE. When the operator accepts the request of the AF, the NEF may request the UDM to add or delete the UE to or from the group such that a group record corresponding to the group and the UE is changed in the UDR based on the information about the group and the information about the UE.

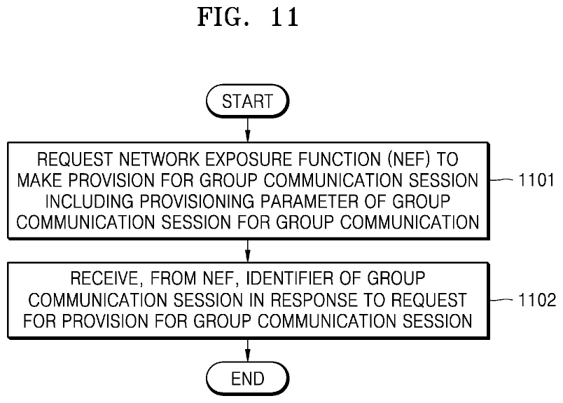

FIG. 11 is a flowchart of a method of supporting a group communication service by an AF, according to some embodiments of the disclosure.

In operation 1101, an AF may request a network exposure function (NEF) to make provision for a group communication session for group communication, the request including provisioning parameters for the group communication session.

In some embodiments, the provisioning parameters for the group communication session may include a group communication identifier tuple, a PDU session type, an IP address allocation method, a DN authorization method, a PDU session capacity, an LADN indicator, a geographical area, whether a service area is limited, a group AMBR, a data network access identifier, etc.

In operation 1102, the AF may receive, from the NEF, an identifier of the group communication session in response to the request for the provision for the group communication session.

Furthermore, in some embodiments, upon reception of the response to the request for the provision for the group communication session from the NEF, the AF may request the NEF to activate the group communication session, the request including provisioning parameters for the group communication session and UE identifiers of the UEs included in the group for group communication.

Moreover, in some embodiments, the AF may request the NEF to add or delete a group for the group communication.

In addition, in some embodiments, the AF may request addition or deletion of a UE to or from a group for group communication.

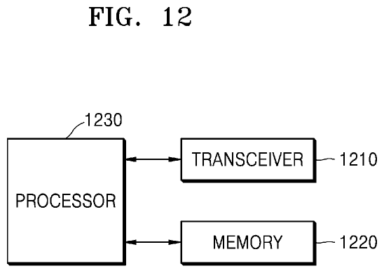

FIG. 12 is a block diagram illustrating a structure of an NF, according to some embodiments of the disclosure.

Referring to FIG. 12, the NF may include a transceiver 1210, a memory 1220, and a processor 1230. The transceiver 1210, the memory 1220, and the processor 1230 of the NF may operate according to the aforementioned operating method of the NF. The structure of the NF shown in FIG. 12 may be applied to all the aforementioned NFs. Components of the NF are not, however, limited thereto. For example, the NF may include more or fewer elements than described above. In addition, the transceiver 1210, the memory 1220, and the processor 1230 may be implemented in a single chip.

The transceiver 1210 may transmit or receive signals to or from another NF. The signals may include control information and data. For this, the transceiver 1210 may include an RF transmitter for up-converting the frequency of a signal to be transmitted and amplifying the signal and an RF receiver for low-noise amplifying a received signal and down-converting the frequency of the received signal. It is merely an example of the transceiver 1210, and the elements of the transceiver 1210 are not limited to the RF transmitter and RF receiver. For example, the transceiver 1210 may be one for wired communication between NFs.

In addition, the transceiver 1210 may receive a signal on a wired or wireless channel and output the signal to the processor 1230, or transmit a signal output from the processor 1230 on a wired or wireless channel.

The memory 1220 may store a program and data required for an operation of the NF. Furthermore, the memory 1220 may store control information or data included in a signal obtained by the NF. The memory 1220 may include a storage medium such as a read only memory (ROM), a random access memory (RAM), a hard disk, a compact disc ROM (CD-ROM), and a digital versatile disc (DVD), or a combination of the storage mediums.

The processor 1230 may control a series of processes for the NF to be operated according to the embodiments of the disclosure. In an embodiment, in a case that the NF is a network exposure function (NEF), the processor 1230 may control the NEF to receive, from an application function (AF), a request to make provision for a group communication session including provisioning parameters for the group communication session for group communication, set up a group communication session for group communication based on the received parameters, and transmit, to the AF, an identifier of the group communication session set up in response to the request, by using the components such as the transceiver 1210 and the memory 1220 to support a group communication service in a wireless communication system.

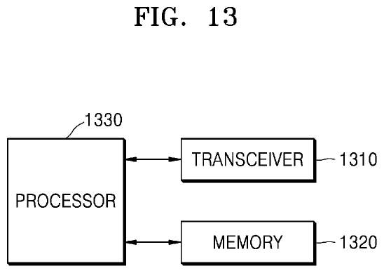

Transceivers, memories, and processors of the NF (i.e., entities) and a UE to implement the embodiments of the disclosure are shown in FIGS. 13 and 14. Information may be exchanged between the NF and the UE to apply the method of supporting a group communication service in a wireless communication system, and the transceivers, memories, and processors of the NF and the UE need to be operated according to the embodiments to perform the method of supporting a group communication service in the wireless communication system.

FIG. 13 is a block diagram illustrating a structure of a UE, according to some embodiments of the disclosure.

Referring to FIG. 13, the UE may include a transceiver 1310, a memory 1320, and a processor 1330. The transceiver 1310, the memory 1320, and the processor 1330 of the UE may operate according to the aforementioned operating method of the UE. The structure of the UE shown in FIG. 13 may be applied to all the aforementioned UEs. Components of the UE are not, however, limited thereto. For example, the UE may include more or fewer elements than described above. In addition, the transceiver 1310, the memory 1320, and the processor 1330 may be implemented in a single chip.

The transceiver 1310 may transmit or receive signals to or from another UE. The signals may include control information and data. For this, the transceiver 1310 may include an RF transmitter for up-converting the frequency of a signal to be transmitted and amplifying the signal and an RF receiver for low-noise amplifying a received signal and down-converting the frequency of the received signal. It is merely an example of the transceiver 1310, and the elements of the transceiver 1310 are not limited to the RF transmitter and RF receiver. For example, the transceiver 1310 may be one for wired communication between UEs.

In addition, the transceiver 1310 may receive a signal on a wired or wireless channel and output the signal to the processor 1330, or transmit a signal output from the processor 1330 on a wired or wireless channel.

The memory 1320 may store a program and data required for operation of the BS. Furthermore, the memory 1320 may store control information or data included in a signal obtained by the UE. The memory 1320 may include a storage medium such as a ROM, a RAM, a hard disk, a CD-ROM, and a DVD, or a combination of storage mediums.

The processor 1330 may control a series of processes for the UE to be operated according to the embodiments of the disclosure. In an embodiment, in a case that the UE is an application function (AF), the processor 1330 may control the UE to request a network exposure function (NEF) to make provision for a group communication session for group communication, the request including provisioning parameters for the group communication session, and receive, from the NEF, an identifier of the group communication session in return for the request, by using the components such as the transceiver 1313 and the memory 1320 to support a group communication service in the wireless communication system.

The aforementioned embodiments may be performed separately or in combination, or at least some of the respective embodiments may be combined into practice.

Several embodiments of the disclosure have been described, but a person of ordinary skill in the art will understand and appreciate that various modifications can be made without departing the scope of the disclosure. Thus, it will be apparent to those of ordinary skill in the art that the disclosure is not limited to the embodiments of the disclosure, which have been provided only for illustrative purposes. Furthermore, the embodiments of the disclosure may be operated by being combined with one another if necessary. For example, parts of the respective embodiments may be combined to operate a BS and a UE. Although the embodiments of the disclosure are proposed based on NR systems, modifications to the embodiments of the disclosure, which do not deviate from the scope of the disclosure, may be applicable to other systems such as an FDD or TDD LTE system.

While embodiments of the disclosure are disclosed and particular terms are used throughout the specification and drawings, they are just used in a general sense to provide easy descriptions and help understanding of the disclosure and are not intended to limit the scope of the disclosure. Thus, it will be apparent to those of ordinary skill in the art that the disclosure is not limited to the embodiments described, which have been provided only for illustrative purposes.

1. A method of supporting a group communication service by a network exposure function (NEF) in a wireless communication system, the method comprising:
receiving, from an application function (AF), a message requesting configuration of a group including an AF identifier (ID) and an external group ID of the group; and
transmitting, to a unified data management (UDM), a message requesting configuration of the group,
wherein, based on the configuration of the group, at least one of creation of the group, deletion of the group, addition of a member of the group, or deletion of a member of the group is performed.

2. The method of claim 1,
wherein at least one of creation of the group, addition of a member of the group, or deletion of a member of the group is performed based on the configuration of the group, and
wherein the message received from the AF to request configuration of the group comprises a group public subscription identifier (GPSI) of members of the group.

3. The method of claim 1, wherein the message requesting the configuration of the group which is transmitted to the UDM comprises the external group ID of the group and a GPSI of members of the group.

4. The method of claim 1, wherein the message requesting configuration of the group which is received from the AF comprises authorization information for the NEF to authorize the AF.

5. A method of supporting a group communication service by a unified data management (UDM) in a wireless communication system, the method comprising:
receiving, from a network exposure function (NEF), a message requesting configuration of a group; and
configuring the group through a service operation of a unified data repository (UDR),
wherein based on the configuration of the group, at least one of creation of the group, deletion of the group, addition of a member of the group, or deletion of a member of the group is performed.

6. The method of claim 5, wherein the message requesting the configuration of the group which is received from the NEF comprises an external group identifier (ID) of the group and a group public subscription identifier (GPSI) of members of the group.

7. A network exposure function (NEF) for supporting a group communication service in a wireless communication system, the NEF comprising:
a transceiver; and
at least one processor coupled to the transceiver,
wherein the at least one processor is configured to:
receive, from an application function (AF), a message requesting configuration of a group including an AF identifier (ID) and an external group ID of the group, and
transmit, to a unified data management (UDM), a message requesting configuration of the group, and
wherein, based on the configuration of the group, at least one of creation of the group, deletion of the group, addition of a member of the group, or deletion of a member of the group is performed.

8. The NEF of claim 7,
wherein at least one of creation of the group, addition of a member of the group, or deletion of a member of the group is performed based on the configuration of the group, and
wherein the message received from the AF to request configuration of the group comprises a group public subscription identifier (GPSI) of members of the group.

9. The NEF of claim 7, wherein the message requesting the configuration of the group which is transmitted to the UDM comprises the external group ID of the group and a GPSI of members of the group.

10. The NEF of claim 7, wherein the message requesting configuration of the group which is received from the AF comprises authorization information for the NEF to authorize the AF.

11. A unified data management (UDM) for supporting a group communication service in a wireless communication system, the UDM comprising:
a transceiver; and
at least one processor coupled to the transceiver,
wherein the at least one processor is configured to:
receive, from a network exposure function (NEF), a message requesting configuration of a group, and
configure the group through a service operation of a unified data repository (UDR), and
wherein, based on the configuration of the group, at least one of creation of the group, deletion of the group, addition of a member of the group, or deletion of a member of the group is performed.

12. The UDM of claim 11, wherein the message received from the NEF to request configuration of the group comprises an external group identifier of the group and a group public subscription identifier (GPSI) of members of the group.
